(19) United States
(12) Patent Application Publication
(10) Pub. No.: US 2024/0046179 A1
(43) Pub. Date: Feb. 8, 2024

(54) CONTROLLING USER INTERFACE (UI) TRANSITIONS BASED ON BUSINESS PROCESS MODEL AND NOTATION (BPMN) UI FLOWS

(71) Applicant: Telefonaktiebolaget LM Ericsson (publ), Stockholm (SE)

(72) Inventors: Luciano Rosa, Milton (CA); Ganish Katyal, Oakville (CA); Shini Gupta, Oakville (CA)

(21) Appl. No.: 18/265,717

(22) PCT Filed: Dec. 8, 2020
(86) PCT No.: PCT/IB2020/061662

§ 371 Date: Jun. 7, 2023

(51) Int. Cl. G06Q 10/0633; G06F 9/451

(52) U.S. Cl. CPC G06Q 10/0633; G06F 9/451

(57) ABSTRACT

Controlling user interface (UI) transitions based on Business Process Model and Notation (BPMN) UI flows is disclosed herein. In some embodiments, a controller application receives, from a UI application, a first request for a UI page, the first request comprising a flow identifier. The controller application transmits an instruction to a BPMN engine to initiate a BPMN UI flow corresponding to the flow identifier. The controller application receives a process identifier corresponding to the BPMN UI flow from the BPMN engine, and retrieves a current task identifier from the BPMN engine using the process identifier. The controller application then returns, to the UI application, a first response based on the current task identifier. The first response includes current UI page information that indicates a current UI page of a plurality of predefined UI pages to be rendered by the UI application.

### TECHNICAL FIELD

The present disclosure relates to providing user interfaces, and in particular to techniques for customizing and controlling user interface (UI) transitions.

### BACKGROUND

Conventional techniques for providing user interfaces (UIs) enable a high degree of usability combined with refined user interface design. Users of commercial products that provide UIs expect such products to enable a significant degree of customization to allow built-in generic functionality to be augmented with customer- and project-specific requirements. In particular, the ability to modify UI page transitions at run-time and to add supporting logic such as validation and communication with external systems, without changing the UI code, is generally considered to be extremely valuable.

Existing conventional solutions attempt to enable the desired level of customization by providing tools that produce configuration code, which is then interpreted by UIs. In some instances, tools know as code generators may generate UI source code based on definitions. In many cases, the existing conventional solutions rely on proprietary technology, which may be difficult to maintain due to the wide range of possibilities for customizing the UI page transitions and interactions with external systems. Because such solutions involve complex proprietary tools, UI code may be impossible to modify without using the provided tools. However, such tools may fail when attempting to anticipate all possible UI transitions use cases, configurations, and scenarios that a UI may need for a given business model

In addition to the complexity, there may exist a prohibitive cost (e.g., with respect to development lifecycle and maintenance efforts) in developing such solutions following the known and existing patterns of code generators and interpreters of declarative UIs. Moreover, the inability to support customer specific use cases may result in additional costs that may be difficult to foresee.

### SUMMARY

Methods and apparatuses for controlling user interface (UI) transitions based on Business Process Model and Notation (BPMN) UI flows are disclosed herein. Embodiments of a method performed by a controller application executing on a computing node for controlling UI transitions based on a BPMN UI flow are disclosed herein. In some embodiments, the method comprises receiving, from a UI application communicatively coupled to the controller application, a first request for a UI page, the first request comprising a flow identifier. The method further comprises transmitting, to a BPMN engine communicatively coupled to the controller application, an instruction to initiate the BPMN UI flow corresponding to the flow identifier. The method also comprises receiving, from the BPMN engine, a process identifier corresponding to the BPMN UI flow. The method additionally comprises retrieving a current task identifier from the BPMN engine using the process identifier. The method further comprises returning, to the UI application, a first response based on the current task identifier, the first response comprising current UI page information that indicates a current UI page of a plurality of predefined UI pages to be rendered by the UI application.

In some embodiments, the BPMN engine is integrated into the controller application. Some embodiments may provide that the first request further comprises first context information provided by the UI application to the BPMN engine. According to some embodiments, the current UI page information comprises first rendering information for use by the UI application to render the current UI page. In some embodiments, the first response further comprises upcoming page information indicating one or more upcoming UI pages of the plurality of predefined UI pages corresponding to one or more tasks of the BPMN UI flow.

Some embodiments may provide that the method further comprises receiving, from the UI application, a second request to complete a current task by the BPMN engine and provide next UI page information for a next UI page within the BPMN UI flow. The method also comprises retrieving the current task identifier from the BPMN engine using the process identifier. The method additionally comprises instructing the BPMN engine to complete the current task using the current task identifier. The method further comprises retrieving a next task identifier from the BPMN engine using the process identifier. The method also comprises returning, to the UI application, a second response based on the next task identifier, the second response comprising the next UI page information that indicates the next UI page of the plurality of predefined UI pages to be rendered by the UI application.

In some embodiments, the second request comprises one or more task parameters. Some embodiments may provide that the second request further comprises second context information provided by the UI application to the BPMN engine. According to some embodiments, the next UI page information comprises second rendering information for use by the UI application to render the next UI page.

Embodiments of a computing node for controlling UI transitions based on a BPMN UI flow are also disclosed herein. The computing node comprises a network interface, system memory, and processing circuitry communicatively coupled to the network interface and the system memory. The processing circuitry is adapted to receive, from a UI application, a first request for a UI page, the first request comprising a flow identifier. The processing circuitry is further adapted to transmit, to a BPMN engine, an instruction to initiate the BPMN UI flow corresponding to the flow identifier. The processing circuitry is also adapted to receive, from the BPMN engine, a process identifier corresponding to the BPMN UI flow. The processing circuitry is additionally adapted to retrieve a current task identifier from the BPMN engine using the process identifier. The processing circuitry is further adapted to return, to the UI application, a first response based on the current task identifier, the first response comprising current UI page information that indicates a current UI page of a plurality of predefined UI pages to be rendered by the UI application. In some embodiments, the processing circuitry is adapted to perform any of the steps attributed to the processing circuitry in the above-disclosed methods.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a computing node including processing circuitry adapted to control user interface (UI) transitions based on Business Process Model and Notation (BPMN) UI flows according to some embodiments of the present disclosure;

FIG. 2 illustrates one example of a BPMN UI flow that may be used to control UI transitions, according to some embodiments of the present disclosure;

FIG. 3 is a message flow diagram illustrating example communications between and operations performed by the controller application and the UI application of FIG. 1, according to some embodiments of the present disclosure;

FIG. 4 is a message flow diagram illustrating additional example communications between and operations performed by the controller application and the UI application of FIG. 1, according to some other embodiments of the present disclosure;

FIGS. 5A and 5B are flowcharts illustrating example operations for controlling UI transitions based on a BPMN UI flow, according to some embodiments of the present disclosure;

FIG. 6 is a schematic block diagram of a computing node according to some embodiments of the present disclosure;

FIG. 7 is a schematic block diagram that illustrates a virtualized embodiment of the computing node of FIG. 6 according to some embodiments of the present disclosure; and

FIG. 8 is a schematic block diagram of the computing node of FIG. 6 according to some other embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Methods and apparatuses for controlling user interface (UI) transitions based on Business Process Model and Notation (BPMN) UI flows are disclosed herein. As noted above, there exist certain challenges with existing solutions. In particular, conventional solutions for building UIs with the level of customization expected by customers may be based on proprietary frameworks rather than existing standards, which may result in a low level of UI reusability and higher maintenance costs.

Accordingly, certain aspects of the present disclosure and their embodiments may provide solutions to the aforementioned or other challenges. In this regard, in the present disclosure, embodiments of apparatuses and methods of operation thereof are proposed for controlling user interface UI transitions based on BPMN UI flows. In some embodiments, a computing node executes a controller application for controlling UI transitions based on a BPMN UI flow. As used herein, the terms “Business Process Model and Notation,” “BPMN,” and variants and derivatives thereof refer generally to any version of the BPMN open standard notation system for modeling business processes, including BPMN version 2.0. A “BPMN UI flow” is a BPMN representation of a UI flow for a specific business process, and may include flow objects such as events (e.g., a start event or an end event), activities (e.g., an individual task or a sub-process comprising multiple tasks), and gateways that indicate where the BPMN UI flow may fork or merge.

The controller application acts as an intermediary between a UI application that generates a UI for a user, and a BPMN engine that handles the user's navigation through the BPMN UI flow. The BPMN engine may comprise any commercially available BPMN engine, and in some embodiments may be incorporated as part of the controller application. In conventional operation, the controller application receives a first request for a UI page from the UI application. The first request includes a flow identifier that identifies the BPMN UI flow provided by the BPMN engine, and in some embodiments may also include first context information provided by the UI application to the BPMN engine. The controller application then transmits an instruction to the BPMN engine to initiate the BPMN UI flow corresponding to the flow identifier.

The controller application subsequently receives a process identifier corresponding to the BPMN UI flow from the BPMN engine. The controller application uses the process identifier to retrieve a current task identifier from the BPMN engine, where the current task identifier corresponds to a task of the BPMN UI flow. Finally, the controller application returns a first response, based on the current task identifier, to the UI application. The first response includes current UI page information that indicates a current UI page of a plurality of predefined UI pages to be rendered by the UI application. In some embodiments, the current UI page information includes first rendering information for use by the UI application to render the current UI page. The first response according to some embodiments may also include upcoming page information that indicates one or more upcoming UI pages corresponding to one or more tasks of the BPMN UI flow. The upcoming page information may be used by the UI application to render, e.g., page navigation functionality to facilitate user navigation of the UI pages corresponding to the tasks of the BPMN UI flow.

In some embodiments, the controller application later may receive a second request to complete a current task by the BPMN engine and provide next UI page information for a next UI page within the BPMN UI flow. The second request in some embodiments may also include one or more task parameters and/or second context information provided by the UI application to the BPMN engine. The controller application thus retrieves the current task identifier from the BPMN engine using the process identifier and instructs that the BPMN engine to complete the current task using the current task identifier. The controller application then retrieves a next task identifier from the BPMN engine using the process identifier. The controller application finally returns, to the UI application, a second response based on the next task identifier. The second response includes the next UI page information that indicates the next UI page of the plurality of predefined UI pages to be rendered by the UI application. According to some embodiments, the next UI page information may include second rendering information for use by the UI application to render the next UI page.

Embodiments disclosed herein thus address the issues of complexity and cost of existing solutions by reducing the cost of UI customizations and leveraging existing standards by enabling the use of BPMN UI flows to define and control UI page transitions. UI pages are orchestrated by a defined BPMN UI flow that allows for transitions within the BPMN UI flow based on user input from the UI application. The addition of tasks and flow logic to the business process does not require changes to the UI application itself, but rather only to the BPMN UI flow. Consequently, a deployed UI application would not need to be modified or redeployed in response to changes to the BPMN UI flow. Moreover, embodiments disclosed herein leverage market knowledge of BPMN notation for modeling business processes.

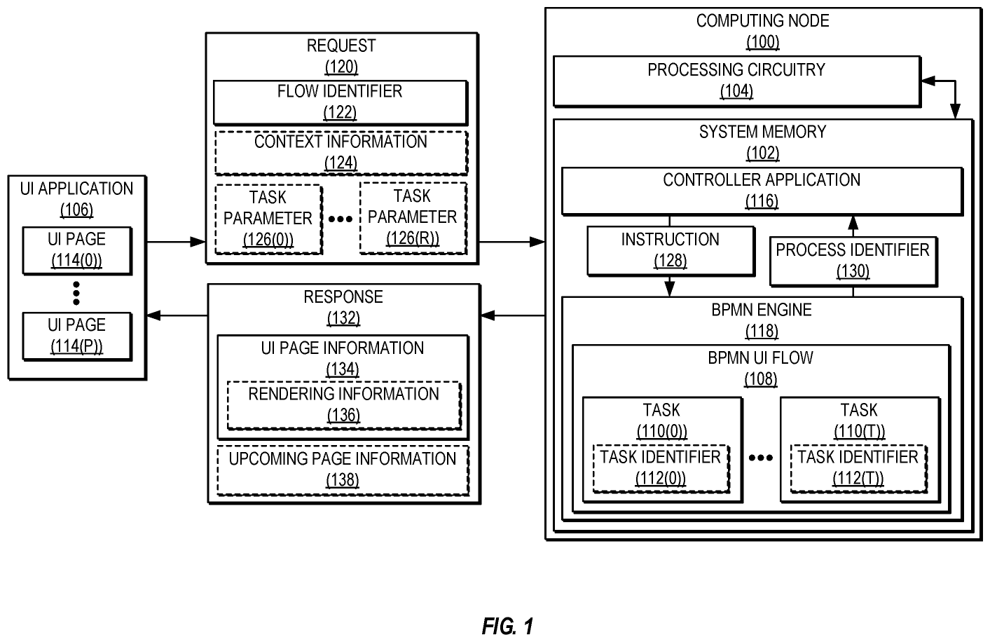

FIG. 1 illustrates an example computing node 100 for controlling UI transitions based on a BPMN flow according to some embodiments of the present disclosure. The computing node 100 in FIG. 1 comprises a system memory 102 and processing circuitry 104 that is communicatively coupled to the system memory 102. The computing node 100 of FIG. 1 and the constituent elements thereof may encompass any one of known digital logic elements, semiconductor circuits, processing cores, and/or memory structures, among other elements, or combinations thereof. Examples described herein are not restricted to any particular arrangement of elements, and it is to be understood that some embodiments of the computing node 100 may include more or fewer elements than illustrated in FIG. 1. For example, the processing circuitry 104 may further include one or more functional units, instruction caches, unified caches, memory controllers, interconnect buses, and/or additional memory devices, caches, and/or controller circuits, which are omitted from FIG. 1 for the sake of clarity.

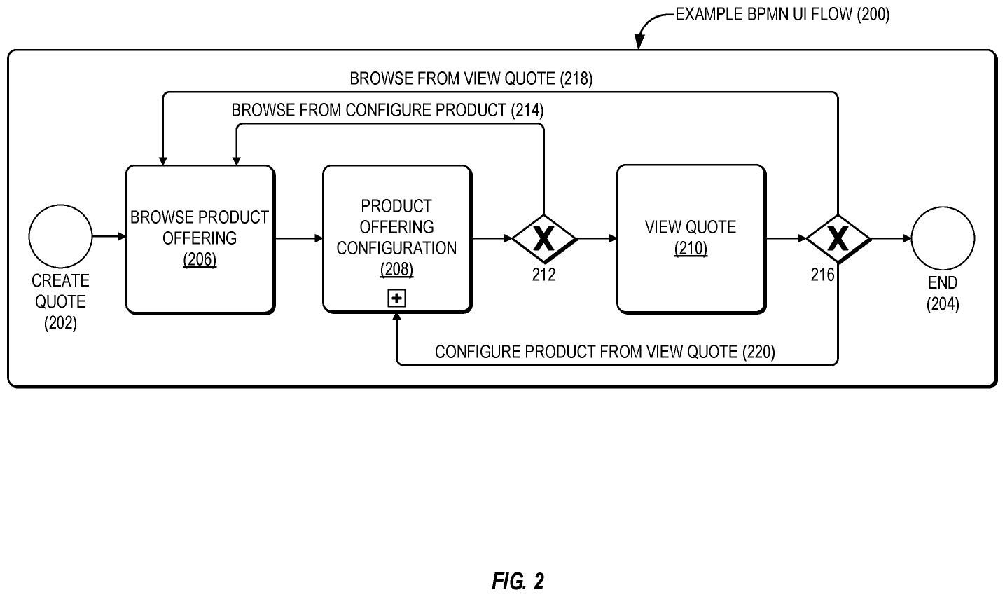

The computing node 100 is communicatively coupled (e.g., via a private network or a public network such as the internet) to a UI application 106. The UI application 106 may execute, e.g., on a client computing node (not shown), and may provide user access to a business process that is represented as a BPMN UI flow 108 of the computing node 100. The BPMN UI flow 108 is modeled to drive and orchestrate a UI, and may include, among other elements, a plurality of tasks 110(0)-110(T) that each correspond to one of a plurality of task identifiers 112(0)-112(T). The constituent elements of an example BPMN UI flow such as the BPMN UI flow 108 of FIG. 1 are discussed in greater detail below with respect to FIG. 2.

The UI application 106 comprises a plurality of predefined UI pages (“UI PAGE”) 114(0)-114(P), each of which may define how data received from the computing node 100 is formatted and presented to a user of the UI application 106. In this manner, the UI interface generated by the UI application 106 may be decoupled from the underlying data provided by the computing node 100. However, it is desirable to provide a mechanism for controlling transitions between UI pages such as the UI pages 114(0)-114(P) without the need to hard-code business logic into the UI application 106 itself.

Accordingly, the computing node 100 of FIG. 1 executes a controller application 116, as well as a BPMN engine 118 to which the controller application 116 is communicatively coupled. The controller application 116 may be implemented as a microservice configured to communicate with the UI application 106 via an interface such as a Representational State Transfer (REST) application programming interface (API). The BPMN engine 118 may be any conventional BPMN engine 118 adapted to manage navigation through a BPMN UI flow such as the BPMN UI flow 108. Although illustrated as separate elements in FIG. 1, some embodiments may provide that the BPMN engine 118 may be integrated into the controller application 116 (e.g., as a shared code library or executable component of the controller application 116). The controller application 116 acts as an intermediary between the UI application 106 and the BPMN engine 118 by receiving requests from the UI application 106, communicating with the BPMN engine 118 on behalf of the UI application 106, and sending responses to the UI application 106 containing information for use in rendering the UI pages 114(0)-114(P).

In example operation, the controller application 116 first receives a request 120 for a UI page from the UI application 106. The request 120 includes a flow identifier 122 that corresponds to the BPMN UI flow 108. In some embodiments, the request 120 may also include context information 124 provided by the UI application 106 to the BPMN engine 118. The context information 124 may include data such as state information persisted from an earlier UI page, data indicating a user selection or user-initiated operation, information captured in a UI form, information indicating an alteration in execution of the BPMN UI flow 108, and/or other metadata, as non-limiting examples. If the UI page being requested by the UI application 106 corresponds to a task of the tasks 110(0)-110(T) that requires or accepts input parameters, the request 120 in some embodiments may also include one or more task parameters 126(0)-126(R).

If the request 120 corresponds with a request to initiate the BPMN UI flow 108, the controller application 116 transmits an instruction 128 to initiate the BPMN UI flow 108 to the BPMN engine 118. The controller application 116 then receives a process identifier 130 that corresponds to the BPMN UI flow 108. The controller application 116 also retrieves a task identifier, such as one of the task identifiers 112(0)-112(T) using the process identifier 130. The controller application 116 then returns a response 132 to the UI application 106. The response 132 includes UI page information 134 that indicates a UI page, such as the UI page 114(0), of the plurality of predefined UI pages 114(0)-114(P) to be rendered by the UI application 106. In some embodiments, the UI page information 134 also includes rendering information 136 that may be used by the UI application 106 to render the UI page 114(0). Some embodiments may also include upcoming page information 138 that indicates one or more upcoming UI pages of the plurality of predefined UI pages 114(0)-114(P) corresponding to one or more tasks 110(0)-110(T) of the BPMN UI flow 108. This may be useful, for example, in rendering page navigation functionality to facilitate user navigation of the UI pages 114(0)-114(P) corresponding to the tasks 110(0)-110(T) of the BPMN UI flow 108.

To illustrate constituent elements of a BPMN UI flow such as the BPMN UI flow 108 of FIG. 1 according to some embodiments of the present disclosure, FIG. 2 is provided. In FIG. 2, an example BPMN UI flow 200 represents activities for a Configure, Price, Quote (CPQ) business process using standard BPMN flowchart shapes. In the BPMN UI flow 200, events that denote an occurrence are represented by circles. Thus, the CPQ business process shown in the BPMN UI flow 200 begins with a Create Quote event 202 and terminates with an End event 204. Activities within the BPMN UI flow 200 are represented by rounded-corner rectangles and denote work done by the business at each step within the BPMN UI flow 200. An activity may involve a single task (i.e., an atomic unit of work that cannot be broken down into lower-level tasks) or may be a sub-process that represents multiple tasks. The activities comprising the CPQ business process illustrated in FIG. 2 include the Browse Product Offering task 206, the Product Offering Configuration sub-process 208, and the View Quote task 210.

Sequence and messaging flows within the BPMN UI flow 200 are represented by connecting objects (e.g., arrows), as well as gateways, represented by diamond shapes, that indicate forking or merging of paths. In the example of FIG. 2, a gateway 212 indicates that the main sequence flow may be diverted from the Product Offering Configuration sub-process 208 back to the Browse Product Offering task 206, as indicated by connecting object 214. Similarly, the gateway 216 indicates that the main sequence flow may be diverted from the View Quote task 210 back to the Browse Product Offering task 206, as indicated by connecting object 218. The main sequence flow may also be diverted from the View Quote task 210 back to the Product Offering Configuration sub-process 208, as indicated by connecting object 220.

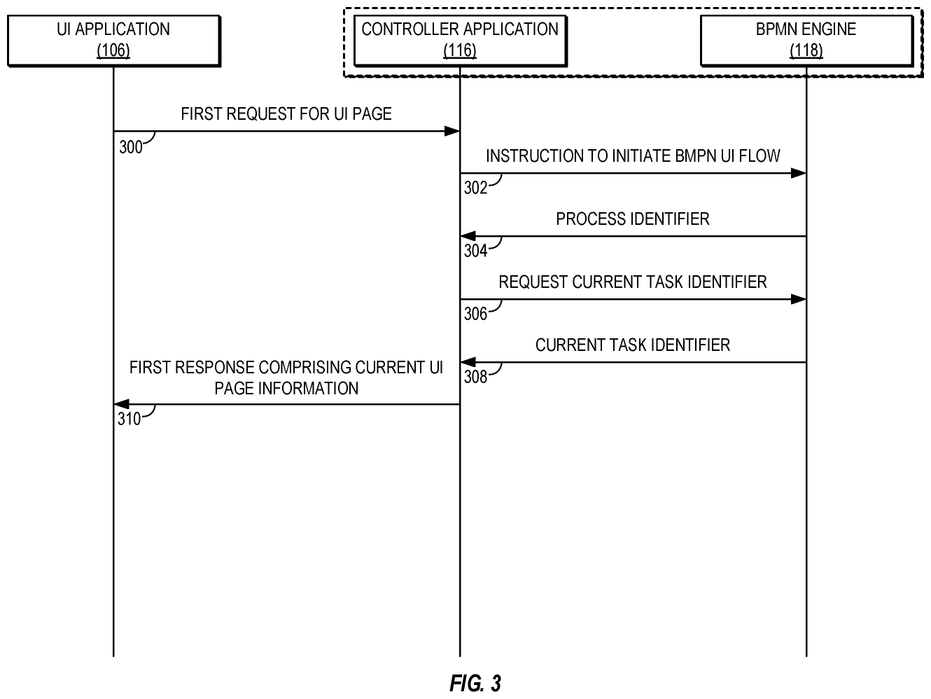

FIG. 3 is a message flow diagram illustrating example communications between and operations performed by elements of FIG. 1 for controlling UI transitions based on a BPMN UI flow, according to some embodiments of the present disclosure. For the sake of clarity, elements of FIG. 1 referenced in describing FIG. 3. The message flow diagram of FIG. 3 shows the UI application 106, the controller application 116, and the BPMN engine 118 of FIG. 1 represented by vertical lines, with communications between these elements illustrated by captioned arrows. It is to be understood that not all of the operations illustrated in FIG. 3 may be performed by all embodiments, and/or that some operations illustrated in FIG. 3 may be performed in an order other than illustrated herein.

Operations in FIG. 3 begin with the controller application 116 receiving a first request, such as the request 120 of FIG. 1, from the UI application 106, as indicated by arrow 300. The first request represents a request for a UI page and comprises a flow identifier, such as the flow identifier 122 of FIG. 1. Upon receiving the first request, the controller application 116 transmits an instruction to initiate the BPMN UI flow 108 (e.g., the instruction 128 of FIG. 1) to the BPMN engine 118, as indicated by arrow 302. The controller application 116 then receives a process identifier corresponding to the BPMN UI flow 108, such as the process identifier 130 of FIG. 1, from the BPMN engine 118, as indicated by arrow 304.

The controller application 116 next uses the process identifier to request a current task identifier from the BPMN engine 118, as indicated by arrow 306. The controller application 116 retrieves the current task identifier, such as the task identifier 112(0) of FIG. 1, from the BPMN engine 118, as indicated by arrow 308. Finally, the controller application 116 returns a first response, such as the response 132, to the UI application 106, as indicated by arrow 310. The first response includes current UI page information, such as the UI page information 134 of FIG. 1, that indicates a current UI page (e.g., the UI page 114(0) of the plurality of predefined UI pages 114(0)-114(P) of FIG. 1) to be rendered by the UI application 106.

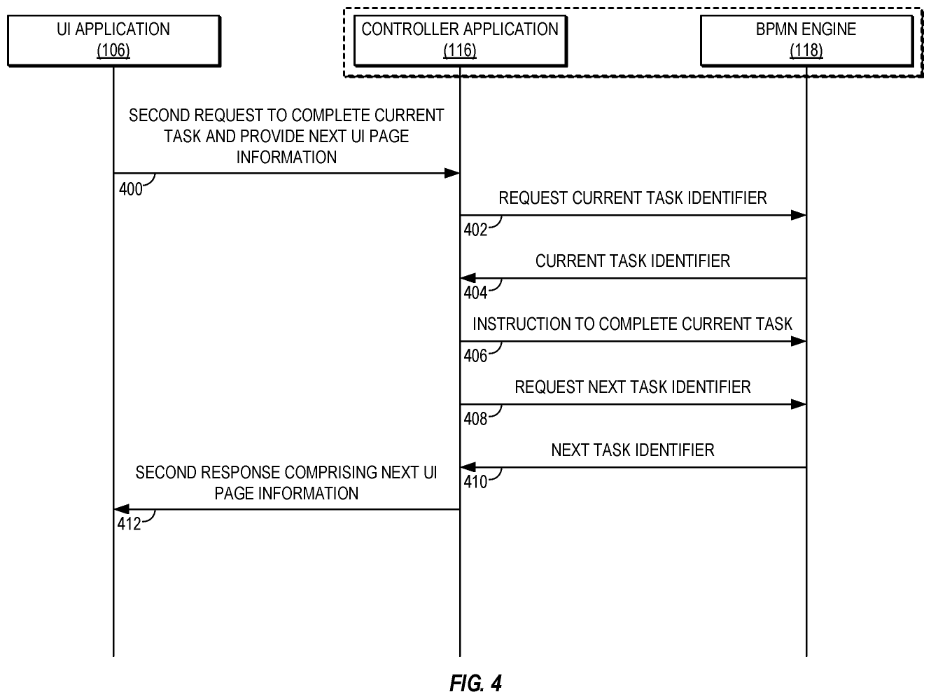

To illustrate additional example communications between and operations performed by elements of FIG. 1 for controlling UI transitions based on a BPMN UI flow according to some other embodiments of the present disclosure, FIG. 4 is provided. Elements of FIG. 1 are referenced in describing FIG. 4 for the sake of clarity. The message flow diagram of FIG. 4 shows the UI application 106, the controller application 116, and the BPMN engine 118 of FIG. 1 represented by vertical lines, with communications between these elements illustrated by captioned arrows. It is to be understood that not all of the operations illustrated in FIG. 4 may be performed by all embodiments, and/or that some operations illustrated in FIG. 4 may be performed in an order other than illustrated herein.

In FIG. 4, operations begin with the controller application 116 receiving a second request (e.g., the request 120 of FIG. 1) from the UI application 106, as indicated by arrow 400. The second request represents a request to complete a current task, such as the task 110(0) of FIG. 1, and provide next UI page information for a next UI page (e.g., the UI page 114(1) of FIG. 1) corresponding to a next task (e.g., the task 110(1) of FIG. 1) of the BPMN UI flow 108. The controller application 116 thus requests a current task identifier (e.g., the task identifier 112(0) of FIG. 1) from the BPMN engine 118 using a process identifier (such as the process identifier 130 of FIG. 1), as indicated by arrow 402. The controller application 116 subsequently receives the current task identifier from the BPMN engine 118, as indicated by arrow 404. The controller application 116 next instructs the BPMN engine 118 to complete the current task using the current task identifier, as indicated by arrow 406.

Next, the controller application 116 requests a next task identifier (e.g., the task identifier 112(1) of FIG. 1) from the BPMN engine 118 using the process identifier, as indicated by arrow 408. The controller application 116 retrieves the next task identifier from the BPMN engine 118, as indicated by arrow 410. The controller application 116 then returns a second response (such as the response 132 of FIG. 1) based on the next task identifier, as indicated by arrow 412. The second response includes next UI page information (e.g., the UI page information 134 of FIG. 1) that indicates a next UI page (e.g., the UI page 114(1) of the plurality of predefined UI pages 114(0)-114(P) of FIG. 1) to be rendered by the UI application 106.

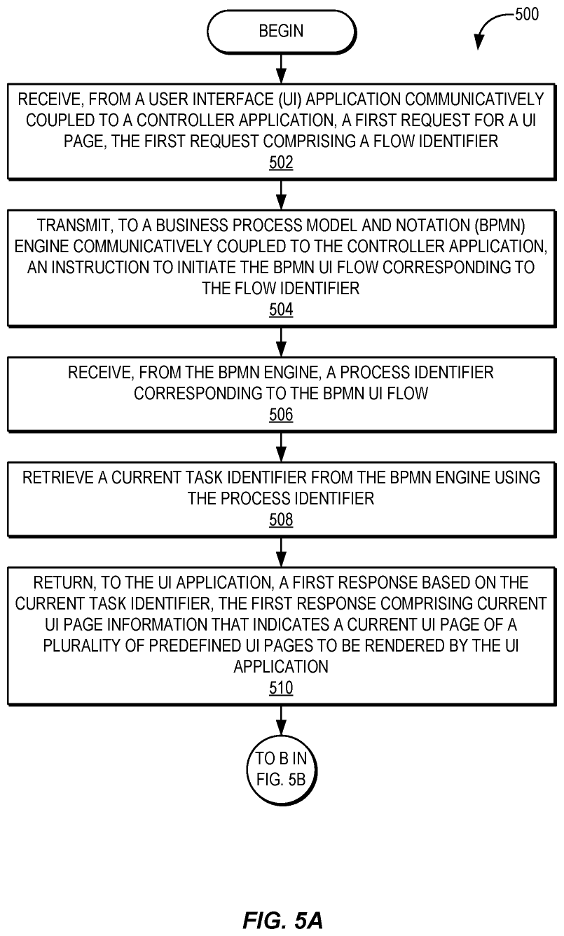

FIGS. 5A and 5B provide a flowchart 500 illustrating example operations for controlling UI transitions based on a BPMN UI flow, according to some embodiments of the present disclosure. Elements of FIG. 1 are referenced in describing FIGS. 5A and 5B for the sake of clarity. In FIG. 5A, operations begin with the UI application 106 receiving a first request (e.g., the request 120 of FIG. 1) for a UI page, the first request 120 comprising a flow identifier (e.g., the flow identifier 122 of FIG. 1) (block 502). The controller application 116 transmits, to the BPMN engine 118 communicatively coupled to the controller application 116, the instruction 128 to initiate the BPMN UI flow 108 corresponding to the flow identifier 122 (block 504). The controller application 116 receives, from the BPMN engine 118, the process identifier 130 corresponding to the BPMN UI flow 108 (block 506). The controller application 116 next retrieves a current task identifier (e.g., the task identifier 112(0) of FIG. 1) from the BPMN engine 118 using the process identifier 130 (block 508). The controller application 116 then returns, to the UI application 106, a first response (e.g., the response 132 of FIG. 1) based on the current task identifier 112(0), the first response comprising current UI page information (e.g., the UI page information 134 of FIG. 1) that indicates a current UI page 114(0) of the plurality of predefined UI pages 114(0)-114(P) to be rendered by the UI application 106 (block 510). In some embodiments, operations then continue at block 512 of FIG. 5B.

Referring now to FIG. 5B, the controller application 116 in some embodiments may receive, from the UI application 106, a second request (e.g., the request 120 of FIG. 1) to complete a current task (e.g., the task 110(0) of FIG. 1) by the BPMN engine 118 and provide next UI page information for a next UI page (e.g., the UI page 114(1) of FIG. 1) corresponding to a next task (e.g., the task 110(1) of FIG. 1) of the BPMN UI flow 108 (block 512). The controller application 116 retrieves the current task identifier 112(0) from the BPMN engine 118 using the process identifier 130 (block 514). The controller application 116 then instructs the BPMN engine 118 to complete the current task 110(0) using the current task identifier 112(0) (block 516). The controller application 116 next retrieves the next task identifier 112(1) from the BPMN engine 118 using the process identifier 130 (block 518). Finally, the controller application 116 returns, to the UI application 106, a second response (e.g., the response 132 of FIG. 1) based on the next task identifier 112(1), the second response comprising the next UI page information (e.g., the UI page information 134 of FIG. 1) that indicates the next UI page 114(1) of the plurality of predefined UI pages 114(0)-114(P) to be rendered by the UI application 106 (block 520).

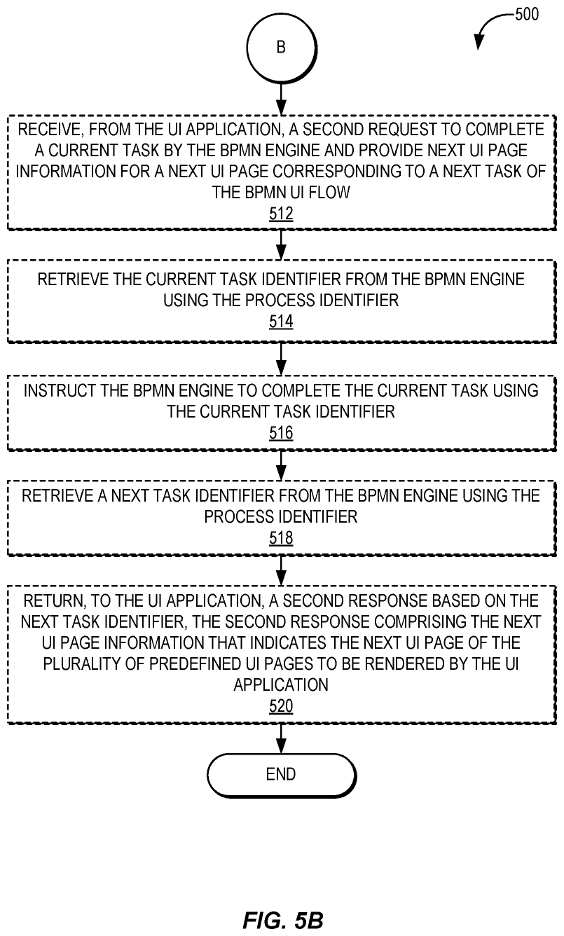

FIG. 6 is a schematic block diagram of a computing node 600 according to some embodiments of the present disclosure. As illustrated, the computing node 600 includes one or more processors 602 (e.g., Central Processing Units (CPUs), Application Specific Integrated Circuits (ASICs), Field Programmable Gate Arrays (FPGAs), and/or the like), memory 604, and a network interface 606. The one or more processors 602 are also referred to herein as processing circuitry, while the memory 604 is also referred to herein as system memory. The one or more processors 602 operate to provide one or more functions of a computing node 600 as described herein. In some embodiments, the function(s) are implemented in software that is stored, e.g., in the memory 604 and executed by the one or more processors 602.

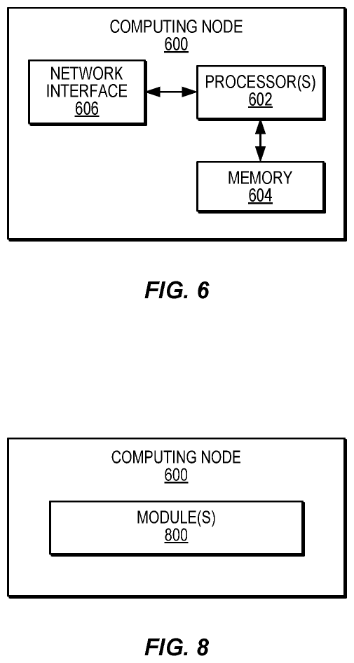

FIG. 7 is a schematic block diagram that illustrates a virtualized embodiment of the computing node 600 according to some embodiments of the present disclosure. This discussion is equally applicable to other types of computing nodes. Further, other types of computing nodes may have similar virtualized architectures.

As used herein, a “virtualized” computing node is an implementation of the computing node 600 in which at least a portion of the functionality of the computing node 600 is implemented as a virtual component(s) (e.g., via a virtual machine(s) executing on a physical processing node(s) in a network(s)). As illustrated, in this example, the computing node 600 includes one or more processing nodes 700 coupled to or included as part of a network(s) 702. Each processing node 700 includes one or more processors 704 (e.g., CPUs, ASICs, FPGAs, and/or the like), memory 706, and a network interface 708.

In this example, functions 710 of the computing node 600 described herein are implemented at the one or more processing nodes 700 or distributed across the one or more processing nodes 700 in any desired manner. In some particular embodiments, some or all of the functions 710 of the computing node 600 described herein are implemented as virtual components executed by one or more virtual machines implemented in a virtual environment(s) hosted by the processing node(s) 700.

In some embodiments, a computer program including instructions which, when executed by at least one processor, causes the at least one processor to carry out the functionality of computing node 600 or a node (e.g., a processing node 700) implementing one or more of the functions 710 of the computing node 600 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

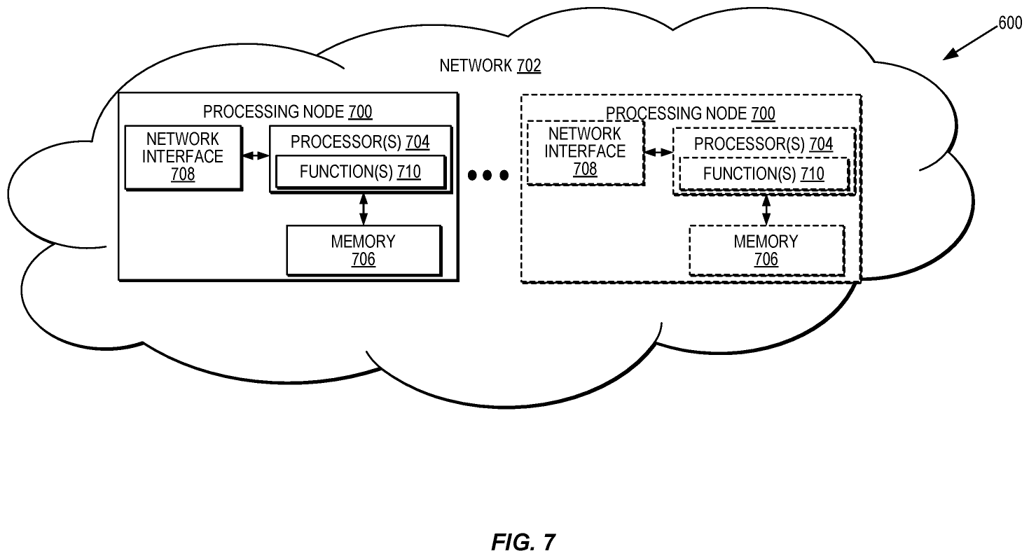

FIG. 8 is a schematic block diagram of the computing node 600 according to some other embodiments of the present disclosure. The computing node 600 includes one or more modules 800, each of which is implemented in software. The module(s) 800 provide the functionality of the computing node 600 described herein. This discussion is equally applicable to the processing node 700 of FIG. 7 where the modules 800 may be implemented at one of the processing nodes 700 or distributed across multiple processing nodes 700 and/or distributed across the processing node(s) 700.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is an example (e.g., alternative embodiments may perform the operations in a different order, combine certain operations, overlap certain operations, etc.).

While not being limited thereto, some example embodiments of the present disclosure are provided below.

Embodiment 1: A method, performed by a controller application (116) executing on a computing node (100), for controlling user interface, UI, transitions based on a Business Process Model and Notation, BPMN, UI flow (108), the method comprising:
receiving (502), from a UI application (106) communicatively coupled to the controller application (116), a first request (120) for a UI page, the first request (120) comprising a flow identifier (122);
transmitting (504), to a BPMN engine (118) communicatively coupled to the controller application (116), an instruction (128) to initiate the BPMN UI flow (108) corresponding to the flow identifier (122);
receiving (506), from the BPMN engine (118), a process identifier (130) corresponding to the BPMN UI flow (108);
retrieving (508) a current task identifier (112(0)) from the BPMN engine (118) using the process identifier (130); and
returning (510), to the UI application (106), a first response (132) based on the current task identifier (112(0)), the first response (132) comprising current UI page information (134) that indicates a current UI page (114(0)) of a plurality of predefined UI pages (114(0)-114(P)) to be rendered by the UI application (106).

Embodiment 2: The method of embodiment 1, wherein the BPMN engine (118) is integrated into the controller application (116).

Embodiment 3: The method of embodiment 1, wherein the first request (120) further comprises first context information (124) provided by the UI application (106) to the BPMN engine (118).

Embodiment 4: The method of embodiment 1, wherein the current UI page information (134) comprises first rendering information (136) for use by the UI application (106) to render the current UI page (114(0)).

Embodiment 5: The method of embodiment 1, wherein the first response (132) further comprises upcoming page information (138) indicating one or more upcoming UI pages (114(1)-114(P)) of the plurality of predefined UI pages (114(0)-114(P)) corresponding to one or more tasks (110(0)-110(T)) of the BPMN UI flow (108).

Embodiment 6: The method of embodiment 1, further comprising:
receiving (512), from the UI application (106), a second request (120) to complete a current task (110(0)) by the BPMN engine (118) and provide next UI page information for a next UI page (114(1)) corresponding to a next task (110(1)) of the BPMN UI flow (108);
retrieving (514) the current task identifier (112(0)) from the BPMN engine (118) using the process identifier (130);
instructing (516) the BPMN engine (118) to complete the current task (110(0)) using the current task identifier (112(0));
retrieving (518) a next task identifier (112(1)) from the BPMN engine (118) using the process identifier (130); and
returning (520), to the UI application (106), a second response (132) based on the next task identifier (112(1)), the second response (132) comprising the next UI page information (134) that indicates the next UI page (114(1)) of the plurality of predefined UI pages (114(0)-114(P)) to be rendered by the UI application (106).

Embodiment 7: The method of embodiment 6, wherein the second request (120) comprises one or more task parameters (126(0)-126(R)).

Embodiment 8: The method of embodiment 6, wherein the second request (120) further comprises second context information (124) provided by the UI application (106) to the BPMN engine (118).

Embodiment 9: The method of embodiment 6, wherein the next UI page information (134) comprises second rendering information (136) for use by the UI application (106) to render the next UI page (114(1)).

Embodiment 10: A computing node (100) for controlling user interface, UI, transitions based on a Business Process Model and Notation, BPMN, UI flow (108), the computing node (100) comprising:
a network interface (606);
a system memory (604); and
processing circuitry (602) communicatively coupled to the network interface (606) and the system memory (604) and adapted to:
   receive (502), from a UI application (106), a first request (120) for a UI page, the first request (120) comprising a flow identifier (122);
   transmit (504), to a BPMN engine (118), an instruction (128) to initiate the BPMN UI flow (108) corresponding to the flow identifier (122);
   receive (506), from the BPMN engine (118), a process identifier (130) corresponding to the BPMN UI flow (108);
   retrieve (508) a current task identifier (112(0)) from the BPMN engine (118) using the process identifier (130); and
   return (510), to the UI application (106), a first response (132) based on the current task identifier (112(0)), the first response (132) comprising current UI page information (134) that indicates a current UI page (114(0)) of a plurality of predefined UI pages (114(0)-114(P)) to be rendered by the UI application (106).

Embodiment 11: The computing node (100) of embodiment 10, wherein the processing circuitry (602) is further adapted to perform the method of any one of embodiments 2 to 9.

At least some of the following abbreviations may be used in this disclosure. If there is an inconsistency between abbreviations, preference should be given to how it is used above. If listed multiple times below, the first listing should be preferred over any subsequent listing(s).
API Application Programming Interface
ASIC Application Specific Integrated Circuit
BPMN Business Process Model and Notation
CPQ Configure, Price, Quote
CPU Central Processing Unit
DSP Digital Signal Processor
FPGA Field Programmable Gate Array
RAM Random Access Memory
REST Representational State Transfer
ROM Read Only Memory
UI User Interface

Those skilled in the art will recognize improvements and modifications to the embodiments of the present disclosure. All such improvements and modifications are considered within the scope of the concepts disclosed herein.

1. A method, performed by a controller application executing on a computing node, for controlling user interface, UI, transitions based on a Business Process Model and Notation, BPMN, UI flow, the method comprising:
receiving, from a UI application communicatively coupled to the controller application, a first request for a UI page, the first request comprising a flow identifier;
transmitting, to a BPMN engine communicatively coupled to the controller application, an instruction to initiate the BPMN UI flow corresponding to the flow identifier;
receiving, from the BPMN engine, a process identifier corresponding to the BPMN UI flow;
retrieving a current task identifier from the BPMN engine using the process identifier; and
returning, to the UI application, a first response based on the current task identifier, the first response comprising current UI page information that indicates a current UI page of a plurality of predefined UI pages to be rendered by the UI application.

2. The method of claim 1, wherein the BPMN engine is integrated into the controller application.

3. The method of claim 1, wherein the first request further comprises first context information provided by the UI application to the BPMN engine.

4. The method of claim 1, wherein the current UI page information comprises first rendering information for use by the UI application to render the current UI page.

5. The method of claim 1, wherein the first response further comprises upcoming page information 4384 indicating one or more upcoming UI pages of the plurality of predefined UI pages corresponding to one or more tasks of the BPMN UI flow.

6. The method of claim 1, further comprising:
receiving, from the UI application, a second request to complete a current task by the BPMN engine and provide next UI page information for a next UI page corresponding to a next task of the BPMN UI flow;
retrieving the current task identifier from the BPMN engine using the process identifier;
instructing the BPMN engine to complete the current task using the current task identifier;
retrieving a next task identifier from the BPMN engine using the process identifier; and
returning, to the UI application, a second response based on the next task identifier, the second response comprising the next UI page information that indicates the next UI page of the plurality of predefined UI pages to be rendered by the UI application.

7. The method of claim 6, wherein the second request comprises one or more task parameters.

8. The method of claim 6, wherein the second request further comprises second context information provided by the UI application to the BPMN engine.

9. The method of claim 6, wherein the next UI page information comprises second rendering information for use by the UI application to render the next UI page.

10. A computing node for controlling user interface, UI, transitions based on a Business Process Model and Notation, BPMN, UI flow, the computing node comprising:
a network interface;
a system memory; and
processing circuitry communicatively coupled to the network interface and the system memory, wherein the processing circuitry is configured to cause the computing node to:
receive, from a UI application, a first request for a UI page, the first request comprising a flow identifier;
transmit, to a BPMN engine, an instruction to initiate the BPMN UI flow corresponding to the flow identifier;
receive, from the BPMN engine, a process identifier corresponding to the BPMN UI flow;
retrieve a current task identifier from the BPMN engine using the process identifier; and
return, to the UI application, a first response based on the current task identifier, the first response comprising current UI page information that indicates a current UI page of a plurality of predefined UI pages to be rendered by the UI application.

11. (canceled)

12. The computing node of claim 10, wherein the BPMN engine is integrated into the controller application.

13. The computing node of claim 10, wherein the first request further comprises first context information provided by the UI application to the BPMN engine.

14. The computing node of claim 10, wherein the current UI page information comprises first rendering information for use by the UI application to render the current UI page.

15. The computing node of claim 10, wherein the first response further comprises upcoming page information indicating one or more upcoming UI pages of the plurality of predefined UI pages corresponding to one or more tasks of the BPMN UI flow.

16. The computing node of claim 10, wherein the processing circuitry is further configured to cause the computing node to:
receive, from the UI application, a second request to complete a current task by the BPMN engine and provide next UI page information for a next UI page corresponding to a next task of the BPMN UI flow;
retrieve the current task identifier from the BPMN engine using the process identifier;
instruct the BPMN engine to complete the current task using the current task identifier;
retrieve a next task identifier from the BPMN engine using the process identifier; and
return, to the UI application, a second response based on the next task identifier, the second response comprising the next UI page information that indicates the next UI page of the plurality of predefined UI pages to be rendered by the UI application.

17. The computing node of claim 16, wherein the second request comprises one or more task parameters.

18. The computing node of claim 16, wherein the second request further comprises second context information provided by the UI application to the BPMN engine.

19. The computing node of claim 16, wherein the next UI page information comprises second rendering information for use by the UI application to render the next UI page.
